(19) United States
(12) Patent Application Publication
(10) Pub. No.: US 2023/0421465 A1
(43) Pub. Date: Dec. 28, 2023

(54) SYSTEMS AND METHODS FOR INTEGRATED FACILITY CONNECTIVITY ASSESSMENTS

(71) Applicant: CommScope Technologies LLC, Hickory, NC (US)

(72) Inventors: Jason W. Reasor, Frisco, TX (US); Ronna Ellen Davis, Henderson, NV (US)

(73) Assignee: CommScope Technologies LLC, Hickory, NC (US)

(21) Appl. No.: 18/255,756

(22) PCT Filed: Oct. 12, 2021
(86) PCT No.: PCT/US2021/054508

§ 371 Date: Jun. 2, 2023

Related U.S. Application Data
(60) Provisional application No. 63/120,572, filed on Dec. 2, 2020.

(51) Int. Cl. H04L 43/045; G06T 19/00; G06T 17/05; H04L 43/0811

(52) U.S. Cl. CPC H04L 43/045; G06T 19/006; G06T 17/05; H04L 43/0811; G06T 2200/24; G06T 2210/56

(57) ABSTRACT

Systems and methods for integrated facility connectivity assessments are provided. In one embodiment, an integrated connectivity assessment system comprises: a user terminal, wherein the user terminal is configured to define a location of interest within a facility; and a backend query and aggregation system, wherein the backend query and aggregation system is configured to query a backend infrastructure information system for connectivity information based on the location of interest and determine a plurality of connectivity metrics for the location of interest based on responses from the backend infrastructure information system, wherein the plurality of connectivity metrics is associated with a plurality of different types of connectivity; wherein the user terminal is configured to present the connectivity metrics on a user interface as an augmented reality presentation over an image of the location of interest.

### CROSS-REFERENCE TO RELATED APPLICATIONS

This is an International Patent Application claiming priority to, and the benefit of, U.S. Provisional Patent Application No. 63/120,572, titled “SYSTEMS AND METHODS FOR INTEGRATED FACILITY CONNECTIVITY ASSESSMENTS” filed on 2 Dec. 2020, which is incorporated herein by reference in its entirety.

### BACKGROUND

When installing networked electronic devises within a facility, such as a building or campus for example, there are several types of connectivity that may be taken into consideration. For example, four primary types of connectivity that are typically used in conjunction with installing a network device in a facility may involve electric power connections, wired network connections, licensed (cellular) network connections, and unlicensed wireless connections (such as connections implemented using one or more of the IEEE 802.11 (“WiFi”) family of standards, for example). A network device may be configured to utilize one or more of these connection types. During the planning process for installing the device, however, it can often be unclear as to what availability exists at a given installation location for the various connection types. For example, an otherwise desirable installation location may be too far from a switch in a telecom room to run a cable for power or wired connectivity. Also, wireless connection signals available at the location may not be sufficient to support the device. Current connectivity information systems do not facilitate an efficient wholistic assessment of multiple connectivity options that may be utilized for installation of the device within the facility.

### SUMMARY

The embodiments of the present disclosure provide methods and systems for integrated facility connectivity assessments and will be understood by reading and studying the following specification.

In one embodiment, an integrated connectivity assessment system comprises: a user terminal, wherein the user terminal is configured to define a location of interest within a facility; and a backend query and aggregation system, wherein the backend query and aggregation system is configured to query a backend infrastructure information system for connectivity information based on the location of interest and determine a plurality of connectivity metrics for the location of interest based on responses from the backend infrastructure information system, wherein the plurality of connectivity metrics is associated with a plurality of different types of connectivity; wherein the user terminal is configured to present the connectivity metrics on a user interface as an augmented reality presentation over an image of the location of interest.

### DRAWINGS

Embodiments of the present disclosure can be more easily understood and further advantages and uses thereof more readily apparent, when considered in view of the description of the preferred embodiments and the following figures in which:

FIG. 1 is block diagram illustrating an example integrated connectivity assessment system embodiment.

FIG. 1A is a diagram illustrating an example embodiment for a graphical representation of a connectivity metric.

FIG. 2 is a flow chart illustrating an example method embodiment for integrated connectivity assessment.

In accordance with common practice, the various described features are not drawn to scale but are drawn to emphasize features relevant to the present disclosure. Reference characters denote like elements throughout figures and text.

### DETAILED DESCRIPTION

In the following detailed description, reference is made to the accompanying drawings that form a part hereof, and in which is shown by way of specific illustrative embodiments in which the embodiments may be practiced. These embodiments are described in sufficient detail to enable those skilled in the art to practice the embodiments, and it is to be understood that other embodiments may be utilized and that logical, mechanical and electrical changes may be made without departing from the scope of the present disclosure. The following detailed description is, therefore, not to be taken in a limiting sense.

Embodiments of the present disclosure provide for a common electronic interface from which a building manager, technician, device installer, or other user, can reference information about the various forms of connectivity available at a given location within a facility for the purpose of determining the acceptability of that location for installing a network device. This interface can show, as a function of geographic location, the availability of multiple connectivity options simultaneously so an installer or building manager can make an intelligent decision around where to install a network device. In some embodiments, the interface may present the connectivity information to a user using augmented reality so that the user may receive the information as an overlay displayed over a live image of the location. In some embodiments, the connectivity information may be distilled into connectivity metrics to more readily facilitate assessments as to whether connectivity options at a given location are acceptable for installing a network device.

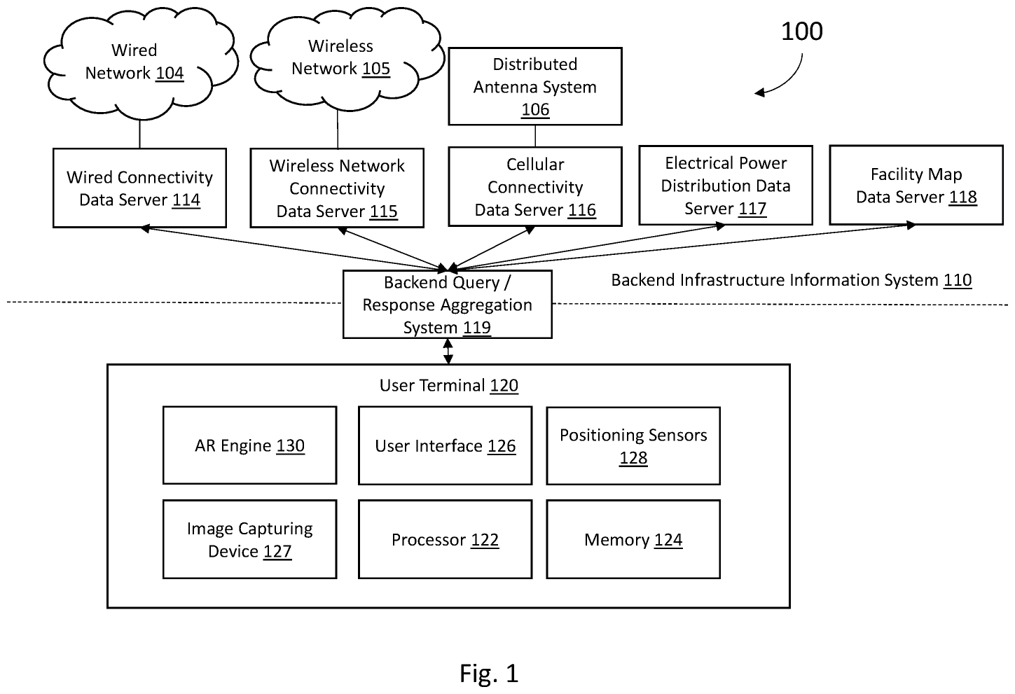

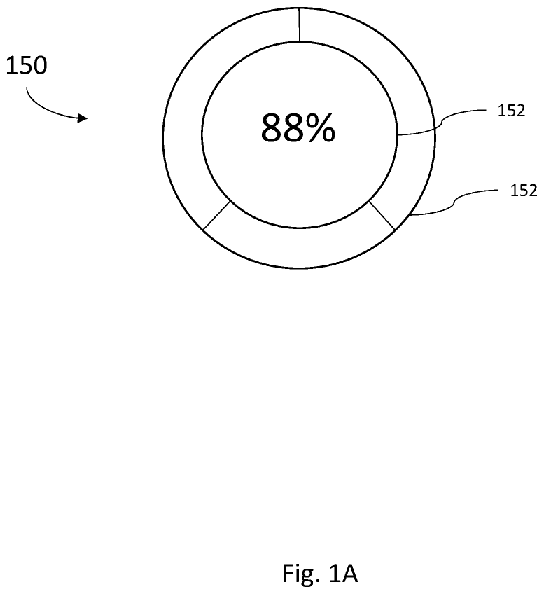

As shown in FIG. 1, the integrated connectivity assessment system 100 includes a user terminal 120 that communicates with at least one backend infrastructure information system 110 in order to determine the types of connectivity options available at selected locations within a facility, and displays to a user connectivity metrics regarding the available connectivity options. In the embodiment shown in FIG. 1, the backend infrastructure information system 110 includes a plurality of connectivity data servers 114-117. These connectivity data servers are each responsive to queries that request the connectivity information for a particular connectivity infrastructure present at the facility. It should be understood that in some embodiments, the functions of one or more of the connectivity data servers 114-117 discussed herein may be integrated into a combined connectivity data server. It should also be understood that in other embodiments, the backend infrastructure information system 110 may include connectivity data servers for types of connectivity other than those shown so that the backend infrastructure information system 110 may comprise other connectivity data servers.

In FIG. 1, a wired connectivity data server 114 provides connectivity information about the physical layer infrastructure for a wired network 104 located at the facility. The wired network 104 may be implemented as an Ethernet local area network or implement another type of wired network. The connectivity information available from the wired connectivity data server 114 may include, for example, the physical location and routing of network cabling, cable trays, risers, network consolidation points, and other network equipment such as network switches and servers. Is should be understood that at the term is used herein, network cabling include cabling comprising optical fibers as well as cables comprising electrical conductors, or hybrid cables including both optical fibers and electrical conductors. The backend infrastructure information system 110 further includes a wireless network connectivity data server 115 that provides wireless connectivity information about a local wireless network 105. In some embodiments, the local wireless network 105 may be a network separate and distinct from the wired network 104. In other embodiments, the local wireless network 105 may comprise a network of wireless access points (AP)s that may be accessed using mobile devices to connect to the wired network 104. The connectivity information available from the wireless network connectivity data server 115 may include, for example, the physical location of the wireless access points of the local wireless network 105 and the wireless standards supported by each wireless access point. The connectivity information available from the wireless network connectivity data server 115 may further include signal strength, signal-to-noise ratios, signal-to-interference-plus-noise ratios (SINR) or other radio frequency channel quality and/or capacity information associated with each of the wireless access points. In some embodiments, the wireless network connectivity data server 115 may be configured with signal quality information maps (discussed in greater detail below) that correlate signal quality information to a specific physical location within the facility based on the wireless access points that provide coverage to that location. It should be appreciated that the method by which the wired connectivity data server 114 and/or the wireless network connectivity data server 115 obtain the connectivity information they store and provide is not limited to any particular technology. The information may be acquired and updated by manual or automatic processes. For example, in some embodiments, one or both of the wired connectivity data server 114 and the wireless network connectivity data server 115 may comprise an automatic infrastructure management (AIM) system, such as a CommScope, Inc. imVision® automated infrastructure management system, or a CommScope, Inc. Ruckus Analytics cloud based network intelligence service.

In the embodiment shown in FIG. 1, the backend infrastructure information system 110 further includes a cellular network connectivity data server 116. In some embodiments, the cellular network connectivity data server 116 provides cellular network connectivity information related to a coverage area established within the facility by a distributed antenna system 106. The distributed antenna system 106 may comprise a master unit that is communicatively coupled with one or more cellular base stations, where each base station is coupled to the core network of one or more cellular network providers. The distributed antenna system 106 further comprises a plurality of remote antenna units coupled to the master unit. The remote antenna units are distributed throughout the facility thus expanding the coverage area of the one or more cellular base stations into the facility. The connectivity information available from the cellular network connectivity data server 116 may include, for example, the physical location of the remote antenna units of the distributed antenna system 106, and the wireless standards supported by each remote antenna unit, and/or the cellular service provider accessible through each remote antenna unit. The connectivity information available from the cellular network connectivity data server 116 may further include signal strength, signal-to-noise ratios, signal-to-interference-plus-noise ratios (SINR) or other radio frequency channel quality and/or capacity information associated with each of the remote antenna units of the distributed antenna system 106. In some embodiments, the cellular network connectivity data server 116 may be configured with signal quality information maps (discussed in greater detail below) that correlate signal quality information to a specific physical location within the facility based on the remote antenna units that provide coverage to that location. It should be appreciated that the method by which the cellular network connectivity data server 116 obtains the connectivity information stored and provided is not limited to any particular technology. The information may be acquired and updated by manual or automatic processes. In some embodiments, the cellular network connectivity data server 116 may be implemented by a DAS management system, such as the CommScope, Inc. Andrew Integrated Management and Operating System (A.I.M.O.S.) or other DAS management system.

In the embodiment shown in FIG. 1, the backend infrastructure information system 110 may further optionally include an electrical power distribution system data server 117 that provides connectivity information regarding facility electrical distribution circuits and cabling. The connectivity information available from the electrical power distribution system data server 117 may include, for example, the physical location and routing of electrical power circuits, circuit panels, power cabling, cable trays, risers, vaults, and corresponding electrical ratings information. The method by which the electrical power distribution system data server 117 obtains the power distribution connectivity information it stores and provides is not limited to any particular technology. The information may be acquired and updated by manual or automatic processes. In some embodiments, the electrical power distribution system data server 117 may comprise a building systems infrastructure management system.

The user terminal 120 provides a common user interface that is integrated with the various distinct data servers of the backend infrastructure information system 110. In some embodiments, the user terminal 120 may comprise a processor 122 coupled to a memory 124. The processor 122 and memory 124 are configured to executed one or more software applications to implement one or more of the functions of the user terminal 120 described herein. In some embodiments, the user terminal 120 may be implemented as a portable user equipment (UE) device, for example, such as a smart phone or tablet computer or wearable computing device. In some embodiments, the user terminal 120 further includes a user interface 126, an image capturing device 127 (for example, a camera), one or more positioning sensors 128, and/or an augmented reality (AR) engine 130. In some embodiments, the image capturing device 127 may further comprise a LIDAR sensor configured to capture 3-dimensional images. The user interface 126 may comprise various forms of human machine interface devices such as, but not limited to, a display screen, touch screen display, a keyboard, a touchpad, a head-mounted display (such as an AR visor or goggles), or the like.

As shown in FIG. 1, the user terminal 120 communicates with the distinct data servers 114-117 of the backend infrastructure information system 110 via a backend query and aggregation system 119 that forwards queries and location information to the backend infrastructure information system 110 and collects and forwards connectivity information received from the responding backend infrastructure information system 110. In some embodiments, the backend query and aggregation system 119 processes the received connectivity information into connectivity metrics as further discussed below. Communications between the user terminal 120 and the backend infrastructure information system 110 may be implemented in various ways including, but not limited to, wireless network or cellular network communications links.

In one embodiment the backend query and aggregation system 119 may be fully implemented on the user terminal 120, such as by code executed by the processor 122. In such an embodiment, the user terminal 120 itself, by utilizing the backend query and aggregation system 119, separately queries the distinct data servers 114-117 of the backend infrastructure information system 110 to obtain the connectivity information. In other embodiments, the backend query and aggregation system 119 may be fully implemented remote from the user terminal 120, such as by any of the data servers 114-118 or other server of the backend infrastructure information system 110. In that case, the user terminal 120 communicates and sends its queries to the remotely located backend query and aggregation system 119 which in turn queries the data servers 114-117 of the backend infrastructure information system 110, collects the responses, processes the received connectivity information into connectivity metrics, and communicates the connectivity metrics back to the user terminal 120 for display by the AR engine 130. In still other embodiments, the functionality attributed the backend query and aggregation system 119 may be distributed with certain functions executed on the user terminal 120 and other functions executed by one or more servers of the backend infrastructure information system 110.

In some embodiments, the AR engine 130 comprises one or more applications that that receive the connectivity metrics from the backend query and aggregation system 119 and present them as an augmented reality display on the user interface 126. For example, the AR engine 130 may display onto the user interface 126 a live image of an area within the facility captured by the image capturing device 127, and superimpose on the live image the connectivity metrics applicable for that area currently being displayed on the user interface 126.

In some embodiments, the positioning sensors 128 may include localization sensors such as, but not limited to, a Global Navigation Satellite System (GNSS) receiver (such as a Global Positioning System (GPS) receiver, or a Galileo receiver), an ultra-wideband (UWB) indoor localization receiver, audio-visual sensors such as cameras and/or microphones, temperature sensors, or other localization technology. In some embodiments, utilizing the location of the user terminal 120 as determined from the positioning sensors 128, the backend query and aggregation system 119 queries the backend infrastructure information system 110 to obtain and aggregate the connectivity information and calculate the connectivity metrics. The positioning sensors 128 may further include one or more inertial sensors, such as accelerometers or gyroscopes, a magnetometer, or other navigation sensors, that provide the AR engine 130 with measurements used to determine the attitude and directional orientation of the user terminal 120 and to correlate the received connectivity metrics with physical elements or structures being displayed in the live image on the user interface 126. In some embodiments, the positioning sensors 128 may be integrated into the user interface 126 in order to obtain the attitude and orientation of the user interface 126.

In some embodiments, the backend query and aggregation system 119 may receive positioning information for the user terminal 120 from other sources, including sources external to the user terminal 120. For example, the positioning of the user terminal 120 may be determined based on identifying one or more wireless access points that the user terminal 120 is utilizing to establish its own connectivity and triangulate using signal strength measurements to assess the location of the user terminal 120 within the facility. This location may be obtained and utilized by the backend query and aggregation system 119 to query the backend infrastructure information system 110 for connectivity data. In other embodiments, combinations of different localization technologies may be utilized to determine a location of the user terminal 120.

In this manner, the user terminal 120 and backend query and aggregation system 119 may function together to define a location of interest within the facility, query the information from the backend infrastructure information system 110, and display resulting connectivity metrics, while the backend infrastructure information system 110 functions to identify connectivity information applicable to the selected location of interest.

Some of the connectivity metrics of interest may be related to wired infrastructure availability at a location of interest within the facility. For example, having determined a location of interest with the user terminal 120, the backend query and aggregation system 119 may use that location to query the wired connectivity data server 114. In response, the wired connectivity data server 114 provides to the backend query and aggregation system 119 connectivity information that comprises an indication of whether or not network cabling is present at that location, and if so, what network cabling is available to support connecting new network devices. For example, the wired connectivity data server 114 may reply with an indication of how many network cables are present, the supported data rates for each of the cables present, and if any of the network cables are configured to provide electrical power to network devices (for example, using Power-over-Ethernet (PoE)). In some embodiments, the initial connectivity metric displayed on the user terminal 120 may simply display an connectivity metric indication as to whether or not network cabling was present. If network cabling is present, the user interface 126 may accept inputs that permit the user to obtain the additional details regarding what is present, and the AR engine 130 will display that information on the user interface 126 in response. If network cabling is not present in at the location, the additional details may indicate a distance to a nearest telecommunications closet or network consolidation point for running a new network cable and the potentially available data rates and/or network provided electrical power capacity.

With respect to electrical power, network cables configured to provide electrical power (for example, using Power-over-Ethernet (PoE)) may not be present so that the use of facility electrical power distribution circuits may be desired. Accordingly, in some embodiments, the backend query and aggregation system may query the electrical power distribution system data server 117 and in response receive connectivity information that comprises an indication of whether or not an electrical power circuit is present at that location. In some embodiments, the initial connectivity metric displayed on the user terminal 120 may simply display an connectivity metric indication as to whether or not an electrical power circuit was present. If an electrical power circuit is present, the user interface 126 may accept inputs that permit the user to obtain the additional details regarding what is present (such as the number of circuits and their power ratings), and the AR engine 130 will display that information on the user interface 126 in response. If an electrical circuit is not present in at the location, the additional details may indicate a distance to a nearest power distribution vault or circuit box for running a new power cable to the location.

Connectivity metrics may also be related to wireless infrastructure availability at a location within the facility, such as the availability of wireless network access or access to a cellular telecommunications network. In some embodiments, the wireless network connectivity data server 115 may maintain signal coverage maps that indicate the signal quality available from the wireless access point at locations throughout the facility. For example, the wireless network connectivity data server 115 may store wireless access point signal coverage quality information for locations within the facility in the form of a “heat map”. In one embodiment, a location of interest is selected via the user terminal 120 in a manner as described above. The location of interest is sent by the backend query and aggregation system 119 to the wireless network connectivity data server 115 with a query for connectivity information. The wireless network connectivity data server 115 correlates the location of interest to a location on a signal coverage map that indicates the signal quality available from wireless access points that cover that location. The signal coverage quality indication may be based on signal strength, signal-to-noise ratio, data rates, or other RF signal quality measurement. Connectivity information may include the signal coverage quality indication and may also include equipment identification (ID) and physical location for the wireless access points providing connectivity to the location. The backend query and aggregation system 119 may then process that signal coverage quality information into the connectivity metric to be displayed by the AR engine 130.

In some embodiments, the connectivity metrics of interest may be related to the available quality of wireless connections to a cellular telecommunications network via the distributed antenna system 106. As discussed above, the distributed antenna system 106 functions to improve the coverage provided by one or more base stations that are coupled to the master unit. These base stations can be coupled to the master unit via one or more cables or via a wireless connection, for example, using one or more donor antennas. The wireless cellular service provided by the base stations can include commercial cellular service and/or private or public safety wireless communications. In one embodiment, the cellular network connectivity data server 116 may maintain signal coverage maps that indicate the signal quality available from the DAS's remote antenna units at locations throughout the facility. For example, the cellular network connectivity data server 116 may store remote antenna unit signal coverage quality information for locations within the facility in the form of a “heat map”. In one embodiment, a location of interest is selected via the user terminal 120 in a manner as described above. That location is sent by the backend query and aggregation system 119 to the cellular network connectivity data server 116.

In some embodiments, the cellular network connectivity data server 116 correlates the location of interest to a location on a cellular signal coverage map that indicates the signal quality available from remote antenna units that cover that location. The signal coverage quality indication may be based on signal strength, signal-to-noise ratio, data rates, or other RF signal quality measurement. Connectivity information may include the signal coverage quality indication and may also include equipment identification (ID) and physical location for the remote antenna units providing connectivity to the location. The backend query and aggregation system 119 may then process that signal coverage quality information into the connectivity metric to be displayed by the AR engine 130.

In some embodiments, the connectivity metrics associated with wireless access point or cellular remote antenna unit signal coverage quality information may be presented in the form of a scale or quality rating using either numeric or a graphical representation of the connectivity metrics. For example, the connectivity metric may be presented as a numeric value from 0 to 100 where 100 indicates that the signal quality meets or exceeds a predetermined signal quality level for service (such as signal strength as measured in decibels (dB) for example). In such an implementation, a value under 100 may indicate a degree to which the available signal strength is less than that predetermined signal quality. The technician would be aware of the threshold connectivity metric value needed based on the requirements of the device to be installed at the location. In other embodiments, the connectivity metric may be presented in other ways, such as using color indicators. For example a green connectivity metric may indicate that the signal quality level at that location is acceptable, yellow may indicate that the signal quality level at that location is marginal, and red may indicate that the signal quality level at that location is not acceptable. FIG. 1A is a diagram illustrating an example graphical representation of connectivity metrics as an graphical symbol 150 that would be displayed on the user interface 126. The graphical symbol 150 may include field to display a numerical value 152 corresponding to a numerical value of the connectivity metric. In some embodiments, the graphical symbol 150 may include a gradated graphical scale where the length and/or color of the graphic corresponds to the connectivity metric and indicates an acceptability of the location. A graphical symbol 150 may be displayed for each of the connectivity metrics for the different connectivity types at that location of interest.

In the various manners describe above, a technician utilizing the user terminal 120 may collect connectivity metrics from each of the types of connectivity and simultaneously observe on the user interface 126 of the user terminal 120 the connectivity metrics from each of the data servers 114-117 in the context of an augmented reality presentation at their location. Such a presentation permits the technician to more quickly and efficiently assess the connectivity types available for installing network connected devices at the location of interest.

As discussed above, the location of interest used to query the data servers 114-117 of the backend infrastructure information system 110 may be determined from the physical location of the user terminal 120 itself. In some embodiments, the physical location of the user terminal 120 as detected may be correlated to a location on a facility map to identify the location of the user terminal 120 as being in a specific segment of the facility map. For example, the backend infrastructure information system 110 may include a facility map data server 118 that includes physical layout maps, such as floorplans, for the facility. The backend query and aggregation system 119 may query the facility map data server 118 to correlate the physical location of the user terminal 120 to a map segment of the facility map, and then query the data servers 114-117 for connectivity information associated with that map segment to gather the connectivity information.

In some embodiments, the technician operating the user terminal 120 may desire connectivity metrics for a location of interest other than the physical location of the user terminal 120, such as a location offset from the user's location. In such an embodiment, the user, thorough the user interface 126, may select a location or interest appearing in the live image that is not within the user terminal 120′s present map segment, but instead falls within an adjacent or otherwise nearby map segment. The backend query and aggregation system 119 may then query the backend infrastructure information system 110 based on the user selected offset location rather than the physical location of the user terminal 120. That is, the backend query and aggregation system 119 would correlate the user selected location of interest to the corresponding map segment of the facility map and then query the data servers 114-117 of the backend infrastructure information system 110 using that selected location's map segment to obtain the connectivity information to produce the connectivity metrics. The AR engine 130 will, in response, display onto the user interface 126 over the live image the connectivity metrics for the selected location of interest. In this way, the technician using the user terminal 120 can position themselves at a central location, and without needing to change their position, reorient the user terminal 120 to capture different portions of the space with the live image displayed on the user interface 126, and obtain connectivity metrics for a plurality of different regions of the facility space in addition to the current location where there are physically located. As discussed above, data from the positioning sensors 128 may be utilized to determine how the user terminal 120 is oriented at its physical location with respect to the facility space to determine what map segments are present within the live image being displayed. In some embodiments, the AR engine 130 may be programed to execute a look-ahead function such that the backend infrastructure information system 110 automatically obtains connectivity information corresponding to a map segment the user terminal 120 is moving towards, but has not yet entered. For example, a technician walking down a hallway with the user terminal 120 may have displayed on the user interface 126 connectivity metrics for their current location, and for one or more locations further down the hallway that fall within other map segments. In this way, the technician can not only assess the suitability of connectivity metrics for the current location for installing a network device, but also immediately ascertain whether nearby locations within the facility have better or worse connectivity metrics for the purpose of installing the network device.

For embodiments where a location used for querying the backend infrastructure information system 110 is determined as a function of an offset from the physical location of the user terminal 120, the facility map may comprise a plurality of 2-dimensional (2D) maps, such as building floor plans. The location of the user terminal 120 can be established by correlating it to a first segment of that 2D map, and then as a function of a relative offset from that first segment (for example, as determined from a user selection input into the user interface 126 or from a look-ahead function) and optionally a sensed orientation of the user terminal 120, a second segment of the 2D map is identified. The location of that second segment may be used to query the data servers 114-117 of the backend infrastructure information system 110 as discussed above.

It should be understood that for at least some embodiments, the user terminal 120 need not be a mobile device. That is, in other embodiments, the user terminal 120 may be statically located, and the AR engine 130 programmed to present a virtual space onto the user interface 126 that represents a physical space of the facility. The technician may input selections into the user interface 126 to virtually travel to the virtual space associate with a physical location of interest, and the backend query and aggregation system 119 would then query the data servers 114-117 of the backend infrastructure information system 110 for connectivity information for that location of interest in any of the same manners as discussed above. That is, the physical location corresponding to the virtual space being virtually occupied could serve as a substitute for the detected physical location of the user terminal 120 in any of the other embodiments described herein. In such embodiments, the facility map data server 118 may optionally store a 3-dimensional (3D) point cloud model of the facility that the AR engine 130 accesses to virtually present the virtual spaces associated with the facility to the user on the user interface 126, with the connectivity metrics corresponding to the location represented by that space. Accordingly, in this embodiment the user terminal 120 may be completely remote from the location for which connectivity metrics are being displayed and there would not be a need for the technician to physically be present near the locations where obtaining connectivity metrics is desired.

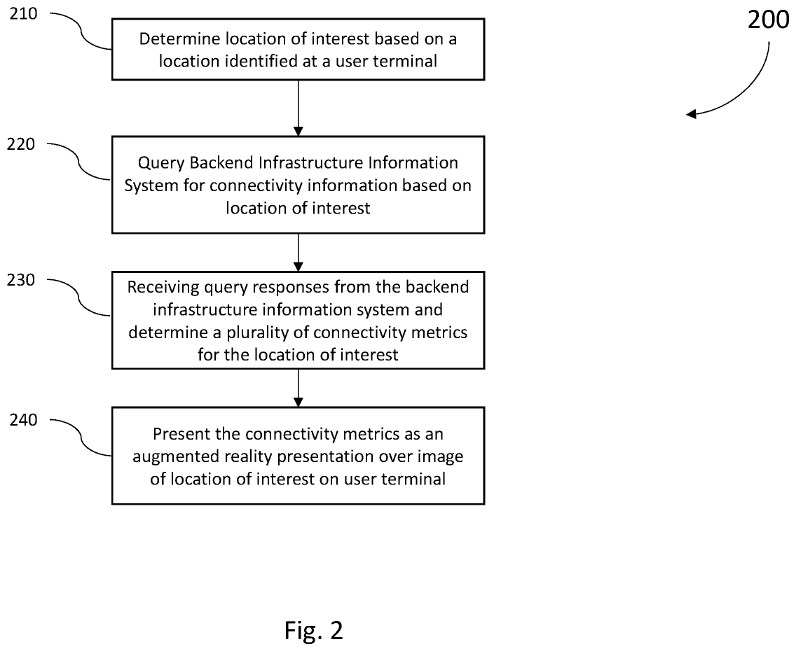

FIG. 2 is a flow chart illustrating an example method 200 embodiment for assessing connectivity. It should be understood that the features and elements described herein with respect to the method 200 shown in FIG. 2 and the accompanying description may be used in conjunction with, in combination with, or substituted for elements of any of the other embodiments discussed with respect to the other figures, or elsewhere herein, and vice versa. Further, it should be understood that the functions, structures and other description of elements associated with embodiments of FIG. 2 may apply to like named or described elements for any of the other figures and embodiments and vice versa.

The method 200 begins at 210 with determining a location of interest based on a location identified at a user terminal. For embodiments comprising a mobile user terminal, the location of interest may be determined as a function of the physical location of the user terminal. In other embodiments, the location of interest may be determined within the context of a virtual space that is representative of physical spaces within the facility. The method proceeds to 220 with querying a backend infrastructure information systems for connectivity information from a plurality of connectivity data servers based on the location of interest. As discussed above, the backend infrastructure information systems may comprise data servers associate with a plurality of different connectivity type that may be relevant for installing a network device within a facility. The data servers respond to the query with connectivity information for the location of interest. The method thus proceeds to 230 with receiving query responses from the backend infrastructure information systems and computing a plurality of connectivity metrics for the location of interest. The method proceed to 240 where the connectivity metrics are presented on the user terminal as an augmented reality presentation over an image of the location of interest. In one embodiment, the image of the location of interest utilized for the augmented reality presentation may be a live image captured by the user terminal. In other embodiments, the image of the location of interest utilized for the augmented reality presentation may be previously captured images mapped to a point cloud model virtual space.

### EXAMPLE EMBODIMENTS

Example 1 includes an integrated connectivity assessment system, the system comprising: a user terminal, wherein the user terminal is configured to define a location of interest within a facility; and a backend query and aggregation system, wherein the backend query and aggregation system is configured to query a backend infrastructure information system for connectivity information based on the location of interest and determine a plurality of connectivity metrics for the location of interest based on responses from the backend infrastructure information system, wherein the plurality of connectivity metrics is associated with a plurality of different types of connectivity; wherein the user terminal is configured to present the connectivity metrics on a user interface as an augmented reality presentation over an image of the location of interest.

Example 2 includes the system of Example 1, wherein the user terminal is configured to define the location of interest within the facility based on a detected location of the user terminal.

Example 3 includes the system of any of Examples 1-2, wherein the user terminal is configured to define the location of interest within the facility based on an input entered by a user of the user terminal.

Example 4 includes the system of any of Examples 1-3, wherein the backend infrastructure information system comprises a plurality of connectivity data servers that includes at least one of: a wired connectivity data server configured to provide connectivity information for a wired network; a wireless network connectivity data server configured to provide connectivity information for a wireless network; a cellular connectivity data server configured to provide connectivity information for a distributed antenna system for a cellular network; and an electrical power distributed data server configured to provide connectivity information regarding a facility electrical distribution infrastructure.

Example 5 includes the system of any of Examples 1-4, wherein the plurality of connectivity metrics associated with the plurality of different types of connectivity comprise one or more of: a connectivity metric for the location of interest based on signal quality connectivity information for one or more wireless access points of a wireless network; a connectivity metric for the location of interest based on signal quality connectivity information for one or more remote antenna units of a distributed antenna system; a connectivity metric for the location of interest based on connectivity information for a wired network; and a connectivity metric for the location of interest based on connectivity information for electric power availability.

Example 6 includes the system of any of Examples 1-5, wherein the user terminal comprises one of a smart phone, a tablet computer, or a wearable computing device.

Example 7 includes the system of any of Examples 1-6, wherein the user terminal further comprises one or more positioning sensors; wherein the user terminal is configured to determine the location of interest within based on measurements from the positioning sensors.

Example 8 includes the system of any of Examples 1-7, wherein the user terminal comprises: a processor coupled to a memory, wherein the user interface is coupled to the processor; wherein the processor executes an augmented reality (AR) engine, wherein the AR engine is configured to present the connectivity metrics on the user interface.

Example 9 includes the system of Example 8, wherein the AR engine graphically present the connectivity metrics on the user interface.

Example 10 includes the system of any of Examples 8-9, wherein the user terminal further comprises an image capturing device, wherein the AR engine is configured to present the connectivity metrics on the user interface over and image of the location of interest captured by the image capturing device.

Example 11 includes the system of any of Examples 8-10, wherein the user terminal further comprises one or more positioning sensors, wherein the AR engine is configured to present the connectivity metrics on the user interface based on attitude and orientation measurements from the one or more positioning sensors.

Example 12 includes the system of any of Examples 1-11, wherein the backend query and aggregation system is executed at least in part on the user terminal.

Example 13 includes the system of any of Examples 1-12, wherein the backend query and aggregation system is executed at least in part by a server of the backend infrastructure information system.

Example 14 includes the system of any of Examples 1-13, wherein the backend infrastructure information system is configured with signal quality information maps that correlate signal quality information to physical locations within the facility.

Example 15 includes the system of any of Examples 1-14, wherein the backend infrastructure information system comprises a facility map data server that includes a facility map representing a physical layout of the facility; wherein the backend query and aggregation system is configured to query the facility map data server to correlate the location of interest to a map segment of the facility map, and then query the backend infrastructure information system for connectivity information associated with the map segment to request the connectivity information.

Example 16 includes the system of Example 15, wherein the location of interest is selected based on a user input to the user interface selecting a location appearing on the user interface that is not within the map segment of the facility map that the user terminal is located within.

Example 17 includes the system of any of Examples 15-16, wherein the AR engine is configured to execute a look-ahead function that controls the backend query and aggregation system to query the backend infrastructure information system to obtain connectivity information corresponding to a second map segment the user terminal moving towards but not yet entered.

Example 18 includes the system of any of Examples 15-17, wherein the facility map data server stores a 3-dimensional (3D) point cloud model of the facility, wherein the AR engine accesses the 3D point cloud model of the facility to virtually present a virtual space associated with the facility on the user interface, wherein the connectivity metrics corresponding to a physical location represented by the virtual space.

Example 19 includes a method for integrated connectivity assessment, the method comprising: determining a location of interest based on a location identified at a user terminal; querying a backend infrastructure information system for connectivity information based on the location of interest; receiving query responses from the backend infrastructure information system and computing a plurality of connectivity metrics for the location of interest; and presenting on a user interface of the user terminal the connectivity metrics as an augmented reality presentation over an image of the location of interest.

Example 20 includes the method of Example 19, wherein the plurality of connectivity metrics comprise one or more of: a connectivity metric for the location of interest based on signal quality connectivity information for one or more wireless access points of a wireless network; a connectivity metric for the location of interest based on signal quality connectivity information for one or more remote antenna units of a distributed antenna system; a connectivity metric for the location of interest based on connectivity information for a wired network; and a connectivity metric for the location of interest based on connectivity information for electric power availability.

Example 21 includes the method of any of Examples 19-20, wherein determining a location of interest based on a location identified at a user terminal comprises defining the location of interest within a facility based on a detected location of the user terminal.

Example 22 includes the method of any of Examples 19-21, wherein determining a location of interest based on a location identified at a user terminal comprises defining the location of interest based on an input entered by a user of the user terminal.

Example 23 includes the method of any of Examples 19-22, wherein presenting on the user terminal the connectivity metrics comprises graphically presenting the connectivity metrics on the user interface.

Example 24 includes the method of any of Examples 19-23, wherein the backend infrastructure information system comprises a facility map data server that includes a facility map representing a physical layout a facility, the method further comprising: querying the facility map data server to correlate the location of interest to a map segment of the facility map; and querying the backend infrastructure information system for connectivity information associated with the map segment to request the connectivity information.

Example 25 includes the method of Example 24, wherein determining a location of interest based on a location identified at a user terminal further comprises: selecting the location of interest based on a user input to the user interface by selecting a location appearing on the user interface that is not within the map segment of the facility map that the user terminal is located within.

Example 26 includes the method of any of Examples 24-25, further comprising executing a look-ahead function that controls a backend query and aggregation system to query the backend infrastructure information system to obtain connectivity information corresponding to a second map segment the user terminal moving towards but not yet entered.

Example 27 includes the method of any of Examples 24-26, wherein the facility map data server stores a 3-dimensional (3D) point cloud model of the facility, the method further comprising: accessing the 3D point cloud model of the facility to virtually present a virtual space associated with the facility on the user interface, wherein the connectivity metrics corresponding to a physical location represented by the virtual space.

In various alternative embodiments, system and/or device elements, method steps, or example implementations described throughout this disclosure (such as any of the networks, data servers, backend query and aggregation system, user terminal, AR engine, user interface, or any controllers, circuits, or sub-parts thereof, for example) may be implemented at least in part using one or more computer systems, field programmable gate arrays (FPGAs), or similar devices comprising a processor coupled to a memory and executing code to realize those elements, processes, or examples, said code stored on a non-transient hardware data storage device. Therefore, other embodiments of the present disclosure may include elements comprising program instructions resident on computer readable media which when implemented by such computer systems, enable them to implement the embodiments described herein. As used herein, the term “computer readable media” refers to tangible memory storage devices having non-transient physical forms. Such non-transient physical forms may include computer memory devices, such as but not limited to punch cards, magnetic disk or tape, any optical data storage system, flash read only memory (ROM), non-volatile ROM, programmable ROM (PROM), erasable-programmable ROM (E-PROM), random access memory (RAM), or any other form of permanent, semi-permanent, or temporary memory storage system or device having a physical, tangible form. Program instructions include, but are not limited to computer-executable instructions executed by computer system processors and hardware description languages such as Very High Speed Integrated Circuit (VHSIC) Hardware Description Language (VHDL).

As used herein, network and telecommunications related terms such as “user terminal”, “user equipment”, “user interface”, “data server”, “distributed antenna system”, “master unit”, “remote antenna unit”, “access point”, “local network”, “smart phone”, “tablet computer”, “wearable computing device”, “sensors”, “processor”, “memory” and “infrastructure management system” refer to the names of hardware elements that would be immediately recognized and understood by those of skill in the art of telecommunications and networks and are not used herein as nonce words or nonce terms for the purpose of invoking 35 USC 112(f).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the presented embodiments. Therefore, it is manifestly intended that embodiments be limited only by the claims and the equivalents thereof.

What is claimed is:

1. An integrated connectivity assessment system, the system comprising:
a user terminal, wherein the user terminal is configured to define a location of interest within a facility; and
a backend query and aggregation system, wherein the backend query and aggregation system is configured to query a backend infrastructure information system for connectivity information based on the location of interest and determine a plurality of connectivity metrics for the location of interest based on responses from the backend infrastructure information system, wherein the plurality of connectivity metrics is associated with a plurality of different types of connectivity;
wherein the user terminal is configured to present the connectivity metrics on a user interface as an augmented reality presentation over an image of the location of interest.

2. The system of claim 1, wherein the user terminal is configured to define the location of interest within the facility based on a detected location of the user terminal.

3. The system of claim 1, wherein the user terminal is configured to define the location of interest within the facility based on an input entered by a user of the user terminal.

4. The system of claim 1, wherein the backend infrastructure information system comprises a plurality of connectivity data servers that includes at least one of:
a wired connectivity data server configured to provide connectivity information for a wired network;
a wireless network connectivity data server configured to provide connectivity information for a wireless network;
a cellular connectivity data server configured to provide connectivity information for a distributed antenna system for a cellular network; and
an electrical power distributed data server configured to provide connectivity information regarding a facility electrical distribution infrastructure.

5. The system of claim 1, wherein the plurality of connectivity metrics associated with the plurality of different types of connectivity comprise one or more of:
a connectivity metric for the location of interest based on signal quality connectivity information for one or more wireless access points of a wireless network;
a connectivity metric for the location of interest based on signal quality connectivity information for one or more remote antenna units of a distributed antenna system;
a connectivity metric for the location of interest based on connectivity information for a wired network; and
a connectivity metric for the location of interest based on connectivity information for electric power availability.

6. The system of claim 1, wherein the user terminal comprises one of a smart phone, a tablet computer, or a wearable computing device.

7. The system of claim 1, wherein the user terminal further comprises one or more positioning sensors;
wherein the user terminal is configured to determine the location of interest within based on measurements from the positioning sensors.

8. The system of claim 1, wherein the user terminal comprises:
a processor coupled to a memory, wherein the user interface is coupled to the processor;
wherein the processor executes an augmented reality (AR) engine, wherein the AR engine is configured to present the connectivity metrics on the user interface.

9. The system of claim 8, wherein the AR engine graphically present the connectivity metrics on the user interface.

10. The system of claim 8, wherein the user terminal further comprises an image capturing device, wherein the AR engine is configured to present the connectivity metrics on the user interface over and image of the location of interest captured by the image capturing device.

11. The system of claim 8, wherein the user terminal further comprises one or more positioning sensors, wherein the AR engine is configured to present the connectivity metrics on the user interface based on attitude and orientation measurements from the one or more positioning sensors.

12. The system of claim 1, wherein the backend query and aggregation system is executed at least in part on the user terminal.

13. The system of claim 1, wherein the backend query and aggregation system is executed at least in part by a server of the backend infrastructure information system.

14. The system of claim 1, wherein the backend infrastructure information system is configured with signal quality information maps that correlate signal quality information to physical locations within the facility.

15. The system of claim 1, wherein the backend infrastructure information system comprises a facility map data server that includes a facility map representing a physical layout of the facility;
wherein the backend query and aggregation system is configured to query the facility map data server to correlate the location of interest to a map segment of the facility map, and then query the backend infrastructure information system for connectivity information associated with the map segment to request the connectivity information.

16. The system of claim 15, wherein the location of interest is selected based on a user input to the user interface selecting a location appearing on the user interface that is not within the map segment of the facility map that the user terminal is located within.

17. The system of claim 15, wherein the AR engine is configured to execute a look-ahead function that controls the backend query and aggregation system to query the backend infrastructure information system to obtain connectivity information corresponding to a second map segment the user terminal moving towards but not yet entered.

18. The system of claim 15, wherein the facility map data server stores a 3-dimensional (3D) point cloud model of the facility, wherein the AR engine accesses the 3D point cloud model of the facility to virtually present a virtual space associated with the facility on the user interface, wherein the connectivity metrics corresponding to a physical location represented by the virtual space.

19. A method for integrated connectivity assessment, the method comprising:
determining a location of interest based on a location identified at a user terminal;
querying a backend infrastructure information system for connectivity information based on the location of interest;
receiving query responses from the backend infrastructure information system and computing a plurality of connectivity metrics for the location of interest; and
presenting on a user interface of the user terminal the connectivity metrics as an augmented reality presentation over an image of the location of interest.

20. The method of claim 19, wherein the plurality of connectivity metrics comprise one or more of:
a connectivity metric for the location of interest based on signal quality connectivity information for one or more wireless access points of a wireless network;
a connectivity metric for the location of interest based on signal quality connectivity information for one or more remote antenna units of a distributed antenna system;
a connectivity metric for the location of interest based on connectivity information for a wired network; and
a connectivity metric for the location of interest based on connectivity information for electric power availability.

21. The method of claim 19, wherein determining a location of interest based on a location identified at a user terminal comprises defining the location of interest within a facility based on a detected location of the user terminal.

22. The method of claim 19, wherein determining a location of interest based on a location identified at a user terminal comprises defining the location of interest based on an input entered by a user of the user terminal.

23. The method of claim 19, wherein presenting on the user terminal the connectivity metrics comprises graphically presenting the connectivity metrics on the user interface.

24. The method of claim 19, wherein the backend infrastructure information system comprises a facility map data server that includes a facility map representing a physical layout a facility, the method further comprising:
querying the facility map data server to correlate the location of interest to a map segment of the facility map; and
querying the backend infrastructure information system for connectivity information associated with the map segment to request the connectivity information.

25. The method of claim 24, wherein determining a location of interest based on a location identified at a user terminal further comprises:
selecting the location of interest based on a user input to the user interface by selecting a location appearing on the user interface that is not within the map segment of the facility map that the user terminal is located within.

26. The method of claim 24, further comprising executing a look-ahead function that controls a backend query and aggregation system to query the backend infrastructure information system to obtain connectivity information corresponding to a second map segment the user terminal moving towards but not yet entered.

27. The method of claim 24, wherein the facility map data server stores a 3-dimensional (3D) point cloud model of the facility, the method further comprising:
accessing the 3D point cloud model of the facility to virtually present a virtual space associated with the facility on the user interface, wherein the connectivity metrics corresponding to a physical location represented by the virtual space.
